(19) United States
(12) Patent Application Publication
(10) Pub. No.: US 2002/0109830 A1
(43) Pub. Date: Aug. 15, 2002

(54) Currency validator

(76) Inventor: Donald Pakman Liu, Las Vegas, NV (US)

Correspondence Address: LEONARD WEISS, 2300 WEST SAHARA AVENUE, BOX 34, LAS VEGAS, NV, 89102

(21) Appl. No.: 09/780,691

(22) Filed: Feb. 9, 2001

(51) Int. Cl. G07D 7/12

(52) U.S. Cl. 356/71

(57) ABSTRACT

A currency validator indicates that a currency specimen is counterfeit when an intensity of uv light reflected from the currency specimen is greater than an expected intensity. Additionally, the currency validator indicates that the currency specimen is a suspected counterfeit specimen when the intensity of infra red light or orange light either reflected from or transmitted through the currency is different from an expected intensity.

### BACKGROUND OF THE INVENTION

1. Field of Invention

This invention is in the general field of detecting counterfeit paper currency and, more particularly, is based upon non-counterfeit currency having a characteristic of being nominally non-reflective of ultra violet light.

2. Description of the Prior Art

Advancements in printing, photocopying and duplicating have caused counterfeiting of paper currency to be a concern of governments and businesses throughout the world. The concern is growing because counterfeit currency frequently passes undetected through a modern currency validator.

Currency validation is predicated upon use of a plurality of validation techniques. The greater the number of validation techniques utilized in the currency validator, the greater the expense in creating counterfeit currency that passes undetected therethrough. Because of the expense, the probability of the currency validator detecting counterfeit currency is directly related to the number of validation techniques utilized within the currency validator.

The currency validator typically includes means for moving a currency specimen therethrough. A digital signal representation of the currency specimen's position within the currency validator is applied to an input of an e-prom of the currency validator.

Within the currency validator, first and second spectra of light are transmitted through the currency specimen to first and second light transmission sensors, respectively. The first transmission sensor provides an analog signal that has an amplitude directly related to a first spectrum intensity of light that is transmitted through the currency specimen. When a result of the transmission of the first spectrum of light is the first spectrum intensity being different from an expected intensity, the currency specimen is a suspected counterfeit specimen.

The first transmission sensor is connected to an input of an analog to digital (a/d) converter that provides a digital signal representation of the first spectrum intensity. A digital signal representation of the second spectrum intensity is obtained in a similar manner. When a result of the transmission of the second spectrum of light is the second spectrum intensity being different from an expected intensity, the currency specimen is a suspected counterfeit specimen.

Additionally, light is reflected from the currency specimen to a reflected light sensor. The reflected light sensor is connected to an a/d converter that provides a digital signal representation of an intensity of the reflected light. When an intensity of the reflected light is different from an expected intensity, the currency specimen is a suspected counterfeit specimen.

The digital signal representations of the first and second spectra intensities and the intensity of the reflected light collectively form a resulting digital word. The e-prom is programmed to provide an expected digital word at a multiplicity of positions of the currency specimen. When the resulting digital word is the same as the expected digital word at each of the locations, the currency specimen is non counterfeit. The resulting digital word is compared to the expected digital word at each of the locations to determine whether the currency specimen is counterfeit.

There is an expected difference between the intensity of light of the first spectrum and the intensity of the light of the second spectrum that is transmitted through the currency specimen. Correspondingly, there is an expected difference between the intensity of the light of the first spectrum and the intensity of the light of the second spectrum that is reflected from the currency specimen.

When a difference in intensities differs from its expected difference, the currency specimen is a suspected counterfeit specimen. The currency validator includes software programming that causes a detection of an unexpected difference in intensities and thereby detects the counterfeit currency specimen.

There is a type of counterfeit currency specimen that produces aberrations in an intensity of light either transmitted through the specimen or reflected therefrom. The aberrations do not cause an inequality between resulting and expected digital words. The currency validator includes software programming that causes a detection of the aberrations and thereby detects the counterfeit currency specimen.

Magnetic ink is frequently used in the minting of paper currency. When the currency specimen passes through the currency validator, a magnetic detector is used to detect presence of the magnetic ink, thereby adding to the validation techniques used in the currency validator.

Frequently, paper currency, has a characteristic of being nominally non-reflective of ultra violet (uv) light. Heretofore, the characteristic has not been used to add a dimension of currency validation that makes counterfeiting increasingly difficult.

### SUMMARY OF THE INVENTION

An object of the present invention is to detect counterfeit currency.

According to the present invention, when a transmission of uv light to a currency specimen results in the uv light reflected therefrom having an intensity greater than an expected intensity, the currency specimen is a suspected counterfeit specimen.

Apparatus in accordance with the invention is readily incorporated in a currency validator to add another dimension of currency validation.

Other objects, features and advantages of the invention should be apparent from the following description of the preferred embodiment thereof as illustrated in the accompanying drawing.

### BRIEF DESCRIPTION OF THE DRAWING

FIG. 1 is a plan view of a non-counterfeit currency specimen that is illuminated by a transmission of ultra violet (uv) light;

FIG. 2 is a plan view of a counterfeit currency specimen that is illuminated by the transmission of uv light;

FIG. 3 is a plan view of a currency specimen that has an encircled portion with fluorescent printing therein;

FIG. 4 is a view of the encircled portion of FIG. 3 when it is illuminated by the transmission of uv light;

FIG. 5 is a view of the encircled portion of FIG. 3 through an optical filter when the encircled portion is illuminated by the transmission of uv light;

FIG. 6 is a simplified perspective view of the preferred embodiment of the present invention;

FIG. 7 is a simplified side elevation of a portion of the embodiment of FIG. 6; and

FIG. 8 is a simplified side elevation of the embodiment of FIG. 6.

### DESCRIPTION OF THE PREFERRED EMBODIMENT

As shown in FIG. 1, a non-counterfeit currency specimen 10 is illuminated by a transmission of uv light. The specimen 10 appears to be dark because the transmission of the uv light to the specimen 10 results in a low intensity of uv light being reflected therefrom,

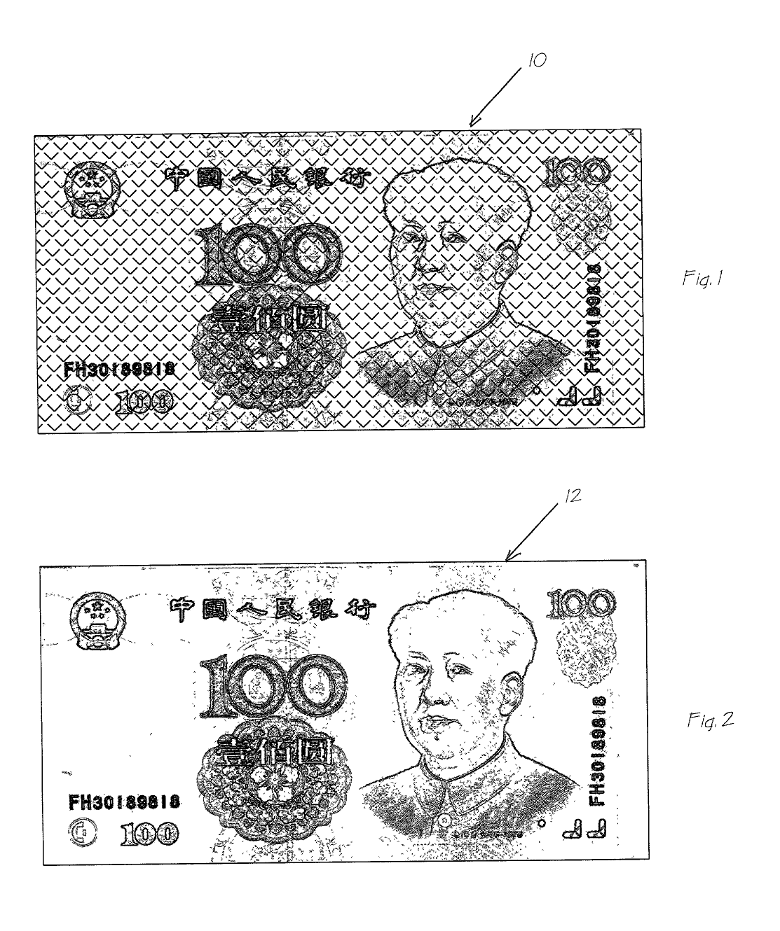

As shown in FIG. 2, a counterfeit currency specimen 12 is illuminated by the transmission of the uv light. The specimen 12 appears to be bright because the transmission of the uv light to the specimen 12 results in a high intensity of uv light being reflected therefrom. According to the present invention, when a transmission of uv light to an exemplary currency specimen results in a reflection of uv light therefrom having an intensity that is greater than an expected intensity, the exemplary currency specimen is a suspected counterfeit specimen.

Frequently, currency is minted with fluorescent characters printed thereon. The fluorescent characters are invisible under normal conditions of ambient lighting. However, fluorescent light is emitted by the characters in response to the uv light whereby the characters become visible.

FIG. 3, is a showing of a non-counterfeit currency specimen 14 under the normal conditions of ambient lighting. The specimen 14 has an encircled region 16 with fluorescent numeric characters, 100, printed thereon. There is an absence of the uv light, thereby causing the fluorescent characters to be invisible.

As shown in FIG. 4, the uv light causes the fluorescent emission whereby the fluorescent characters are visible. However, all other portions of the region 16 are dark.

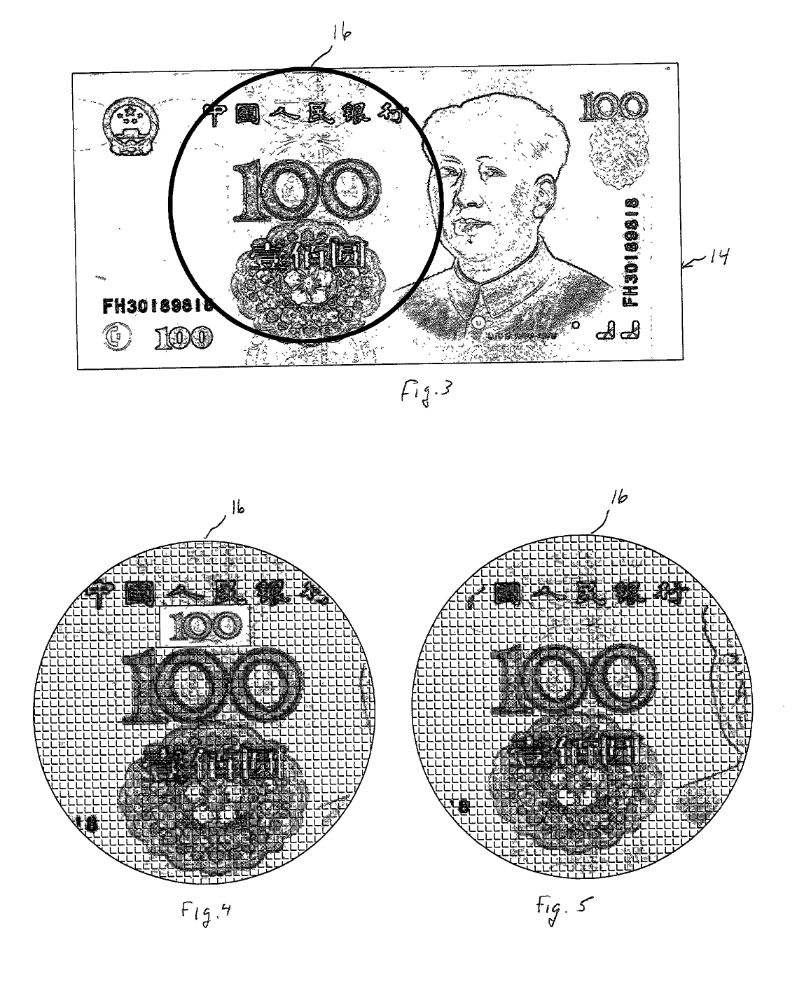

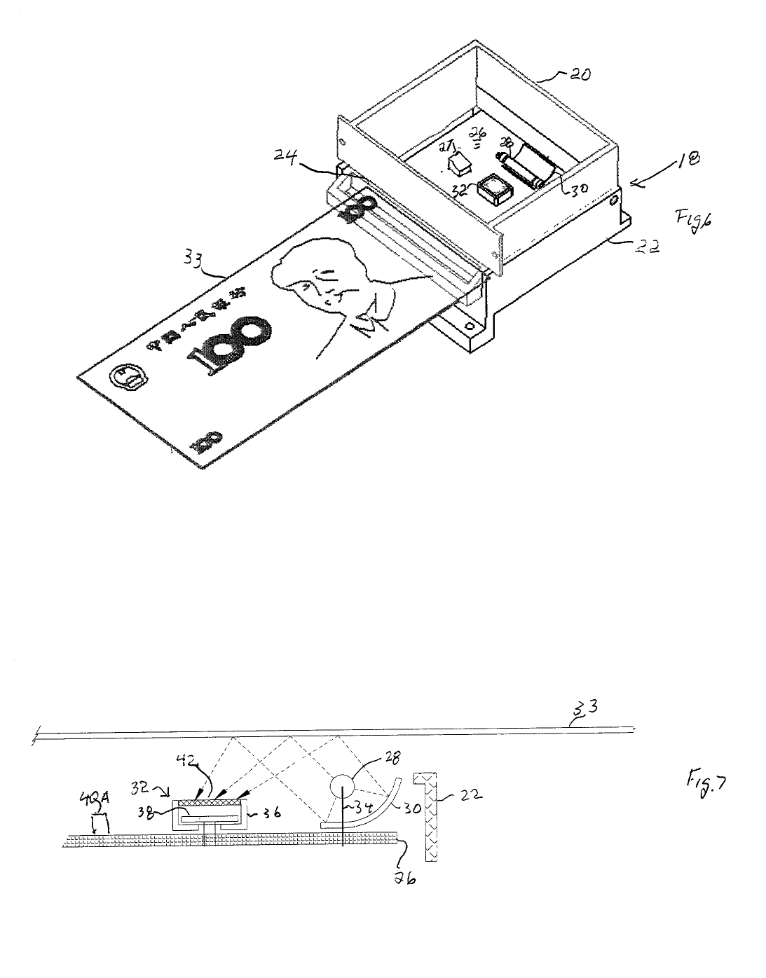

As shown in FIG. 5, when the region 16 is viewed through an optical filter (not shown) the fluorescent characters are invisible, thereby causing the region 16 to be entirely darkened. As explained hereinafter, the optical filter prevents the fluorescent emission from being transmitted to a sensor.

As shown in FIG. 6, a currency validator 18 includes an upper housing section 20 and a lower housing section 22 that are connected together. For purposes of simplification, a cover on the upper housing 20 is not shown.

A currency specimen 33, with fluorescent characters printed thereon, is insertable into the currency validator 18 through a slot 24. A stepper motor (not shown) is used to move the specimen 33 within the currency validator 18. Stepper motors are well known to those skilled in the art.

A printed circuit board 26 is positioned within the lower housing 22. An e-prom 27 is mounted on the circuit board 26. While the specimen 33 is within the currency validator 18, a digital signal representation of the position of the specimen 33 is generated in any suitable manner and applied to input terminals of the e-prom 27 for reasons explained hereinafter

A uv light source 28, a reflector 30 and a sensor assembly 32 are mounted on the circuit board 26. Several other components mounted on the circuit board 26 are not shown for purposes of simplification.

When the specimen 33 is within the currency validator 18, it is substantially parallel to the circuit board 26. The uv source 28, the reflector 30 and the sensor assembly 32 are between the circuit board 26 and the specimen 33.

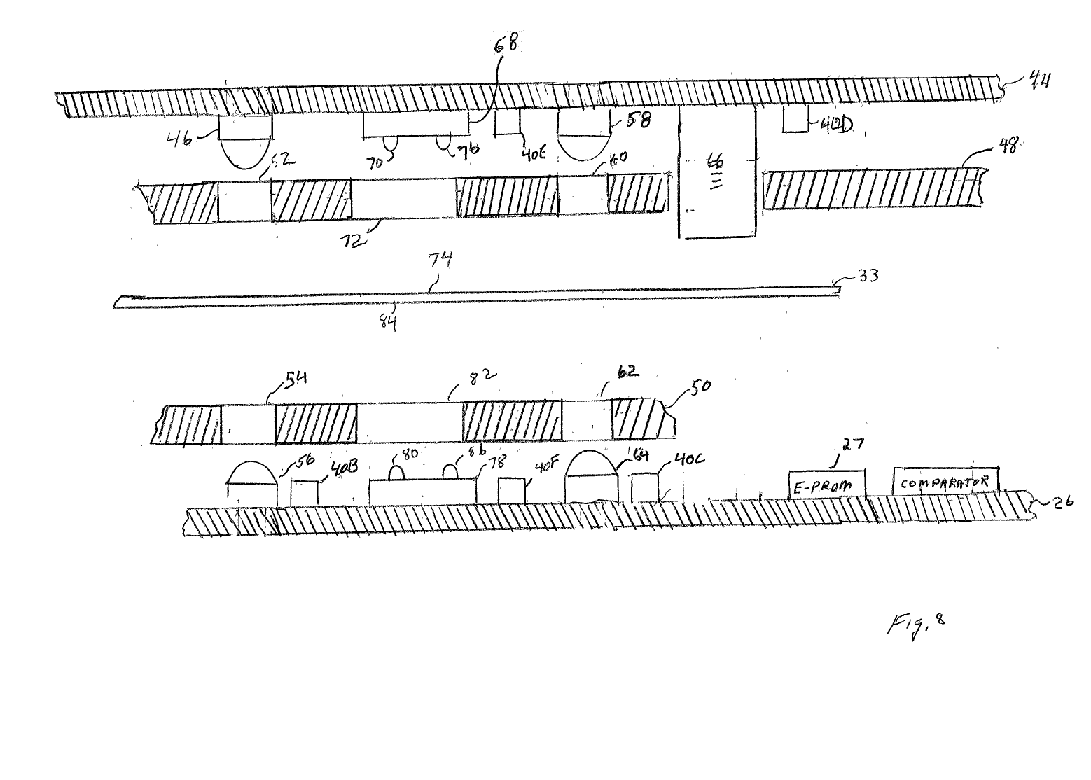

A shown in FIG. 7, the uv source 28 is a tubular structure that has one end connected to the circuit board 26 through a stanchion 34. In a similar manner, a stanchion (not shown) connects the other end of the uv source 28 to the circuit board 26. The uv source 28 is additionally connected through wires (not shown) to the circuit board 26 whereby excitation is applied to the uv source 28.

Light from the uv source 28 is transmitted to the specimen 33. Additionally, light from the uv source 28 is transmitted to the reflector 30 and transmitted via a reflection to the specimen 33.

In response to the light transmitted to the specimen 33, uv light is reflected therefrom and transmitted to the sensor assembly 32. Additionally, there is a fluorescent emission of light from the specimen 33 that is transmitted to the sensor assembly 32.

The sensor assembly 32 includes a frame 36 that is connected to the circuit board 26. A uv sensor voltage is provided by a light sensor 38 that is mounted within the frame 36. The uv sensor voltage has an amplitude proportional to the intensity of light transmitted to the sensor 38. The sensor 38 may, for example, include a photo transistor.

The sensor 38 is connected to an a/d converter 40A at an input thereof through the circuit board 26. The a/d converter 40A provides a digital signal representation of the amplitude of the uv sensor voltage. a/d converters are well known to those skilled in the art.

An optical filter 42 is mounted within the frame 36. Light reflected to the sensor assembly 32 passes through the filter 42 to the sensor 38. Because of the filter 42, the fluorescent emission from the specimen 33 is not transmitted to the sensor 38. Therefore, the uv sensor voltage, unaffected by the fluorescent emission from the specimen 33, has an amplitude proportional to the intensity of uv light reflected from the specimen 33.

When the uv light transmitted to the specimen 33 results in uv light reflected therefrom having an intensity greater than an expected intensity the specimen 33 is a suspected counterfeit specimen. Correspondingly, when the uv sensor voltage has an amplitude greater than an expected amplitude, the specimen 33 is a suspected counterfeit specimen.

In one embodiment, the reflector 30 is a parabolic reflector with the uv source 28 disposed substantially at its focal point. Parabolic reflectors and their use are well known in the art.

As shown in FIG. 8, the currency validator 18 includes a printed circuit board 44 whereon a light emitting diode (LED) 46 is mounted. Wires (not shown) of the LED 46 extend into the circuit board 44 whereby excitation is applied to the LED 46. In response to the excitation, the LED 46 emits an infra red spectrum of light.

The currency validator 18 includes walls 48, 50 that form a passageway for the specimen 33. The walls 48, 50 have holes 52, 54 respectively therethrough.

The circuit board 26 has an infra red light sensor 56 mounted thereon. The sensor 56 is similar to the sensor 38. Infra red light emitted by the LED 46 is transmitted through the hole 52, the specimen 33 and the hole 54 to the sensor 56. In response to the infra red light, the sensor 56 provides an infra red transmission sensor voltage that has an amplitude proportional to the intensity of the infra red light transmitted to the sensor 56.

When the infra red light transmitted by the LED 46 results in the infra red light transmitted to the sensor 56 having an intensity different from an expected intensity, the specimen 33 is a suspected counterfeit specimen. Correspondingly, when the infra red light transmitted by the LED 46 results in the infra red transmission sensor voltage having an amplitude and pattern different from an expected amplitude and pattern, the specimen 33 is a suspected counterfeit specimen.

The sensor 56 is connected to an a/d converter 40B at an input thereof through the circuit board 26. The a/d converter 40B is similar to the a/d 40A. The a/d converter 40B provides a digital signal representation of the amplitude of the infra red transmission sensor voltage.

An LED 58 is mounted on the circuit board 44. Wires (not shown) of the LED 58 extend into the circuit board 44 whereby excitation is applied to the LED 58. In response to the excitation, the LED 58 emits an orange spectrum of light.

The walls 48, 50 have holes 60, 62 respectively therethrough. Additionally, the circuit board 26 has a light sensor 64 mounted thereon. The sensor 64 is similar to the sensor 38. Orange light emitted by the LED 58 is transmitted through the hole 60, the specimen 33 and the hole 62 to the sensor 64. In response to the orange light, the sensor 64 provides an orange light transmission sensor voltage that has an amplitude proportional to the intensity of the orange light transmitted to the sensor 58.

When the orange light transmitted by the LED 58 results in the orange light transmitted to the sensor 64 having an intensity and pattern different from an expected intensity and pattern, the specimen 33 is a suspected counterfeit specimen. Correspondingly, when the orange light transmitted by the LED 58 results in the orange light transmission sensor voltage having an amplitude and pattern different from an expected amplitude and pattern, the specimen 33 is a suspected counterfeit specimen.

The sensor 64 is connected to an a/d converter 40C at an input thereof through the circuit board 26. The a/d converter 40C is similar to the a/d converter 40A. The a/d converter 40C provides a digital signal representation of the amplitude of the orange light transmission sensor voltage.

The circuit board 44 has a magnetic sensor 66 mounted thereon. The sensor 66 provides a magnetic sensor voltage that has an amplitude proportional to a magnetic field intensity proximal to the specimen 33.

When a magnetic field intensity proximal to the specimen 33 is different from an expected magnetic field intensity, the specimen 33 is a suspected counterfeit specimen. Correspondingly, when the amplitude of the magnetic sensor voltage is different from an expected amplitude, the specimen 33 is a suspected counterfeit specimen.

The sensor 66 is connected to an a/d converter 40D at an input thereof through the circuit board 44. The a/d converter 40D is similar to the a/d converter 40A. The a/d converter 40D provides a digital signal representation of the amplitude of the magnetic sensor voltage.

A light source/sensor unit 68 is mounted on the circuit board 44. Excitation is provided to the unit 68 through the circuit board 44. In response to the excitation, an orange spectrum of light is emitted at an output 70 of the unit 68.

The wall 48 has a hole 72 therethrough. Orange light emitted at the output 70 is transmitted through the hole 72 to a surface 74 of the specimen 33 and reflected therefrom.

The unit 68 has a light sensor with an input 76. Orange light reflected from the surface 74 passes through the hole 72 to the input 76. The sensor of the unit 68 provides a reflected orange light sensor voltage that has an amplitude proportional to the intensity of the orange light reflected from the surface 74 to the input 76.

When the orange light transmitted through the hole 72 results in the reflected orange light having an intensity different from an expected intensity, the specimen 33 is a suspected counterfeit specimen. Correspondingly, when the orange light transmitted through the hole 72 results in the reflected orange light sensor voltage having an amplitude different from an expected amplitude, the specimen 33 is a suspected counterfeit specimen.

The unit 68 is connected to an a/d converter 40E through the circuit board 44, whereby the reflected orange light sensor voltage is provided to an input of the a/d 40E. The a/d converter 40E is similar to the a/d converter 40A. The a/d converter 40E provides a digital signal representation of the amplitude of the reflected orange light sensor voltage.

A light source/sensor unit 78 is mounted on the circuit board 26. Excitation is provided to the unit 78 through the circuit board 26. In response to the excitation, an infra red spectrum of light is emitted at an output 80 of the unit 78.

The wall 50 has a hole 82 therethrough. Infra red light emitted at the output 80 is transmitted through the hole 82 to a surface 84 of the specimen 33 and reflected therefrom.

The unit 78 has a light sensor with an input 86. Infra red light reflected from the surface 84 passes through the hole 82 to the input 86. The sensor of the unit 78 provides a reflected infra red light sensor voltage that has an amplitude proportional to the intensity of the infra red light reflected from the surface 84 to the input 86.

When the infra red light transmitted through the hole 82 results in the reflected infra red light having an intensity different from an expected intensity, the specimen 33 is a suspected counterfeit specimen. Correspondingly, when the infra red light transmitted through the hole 82 results in the reflected infra red light sensor voltage having an amplitude different from an expected amplitude, the specimen 33 is a suspected counterfeit specimen.

The unit 78 is connected to an a/d converter 40F through the circuit board 26 whereby the reflected infra red light sensor voltage is applied to an input of the a/d converter 40F. The a/d converter 40F is similar to the a/d converter 40A. The a/d converter 40F provides a digital signal representation of the amplitude of the reflected infra red light sensor voltage.

The digital signal representations of the amplitudes of the sensor voltages collectively form what is referred to as a resulting digital word. The e-prom 27 is programmed to provide what is referred to as an expected digital word. When a non-counterfeit currency specimen, such as the specimen 14, is used to provide the sensor voltages the resulting digital word is same as the expected digital word at any position of the specimen 14 within the currency validator 18.

To compare the resulting and expected digital words, the outputs of the a/d converter 40A (FIG. 7) and the a/d converters 40B-40F are all connected to a first group of input terminals of a digital comparator 88. The outputs of the e-prom 27 are connected to a second group of input terminals of the comparator 88. A signal is provided by the comparator 88 to indicate a difference between the resulting and expected digital words, thereby indicating that a suspected counterfeit specimen is in the currency validator 18.

Preferably, the currency validator 18 additionally includes software that utilizes a detection of differences between intensities of infra red and orange light spectra and aberrations in intensities, described hereinbefore as prior art, to detect a counterfeit currency specimen.

Thus there is described herein a currency validator where a characteristic of a currency being non-reflective of uv light is utilized.

I claim:

1. A currency validator for identifying counterfeit currency, comprising:
a light source that transmits uv light to a currency specimen within the currency validator; and
comparison means for determining when transmitting the uv light results in the specimen reflecting uv light having an intensity that is greater than an expected intensity, whereby the currency specimen is a suspected counterfeit specimen.

2. The currency validator of claim 1, additionally comprising a reflector that reflects uv light from said light source to said currency specimen.

3. The currency validator of claim 2 wherein said reflector is a parabolic reflector having a focal point where said uv source is substantially disposed.

4. The currency validator of claim 1 additionally comprising a sensor assembly that provides a uv sensor voltage having an amplitude that is proportional to the intensity of uv light reflected from said currency specimen said comparison means including means for determining when said uv sensor voltage has an amplitude greater than an expected amplitude.

5. The currency validator of claim 4 wherein said assembly includes a filter that prevents a fluorescent emission of light from said currency specimen from being transmitted to a sensor of said assembly.

6. The currency validator of claim 5 wherein said sensor is a photo sensor.

7. The currency validator of claim 6 wherein said photo sensor is a photo transistor.

8. The currency validator of claim 4 additionally comprising:
a light source that transmits a known spectrum of light to said currency specimen; and
a transmission sensor that provides a transmission sensor voltage having an amplitude proportional to an intensity of light of said known spectrum that is transmitted through said currency specimen, said comparison means including means for determining when said transmission sensor voltage is substantially different from an expected transmission sensor voltage.

9. The currency validator of claim 8 wherein said known light spectrum is orange light.

10. The currency validator of claim 8 wherein said known light spectrum is infra red light.

11. The currency validator of claim 8 additionally comprising:
a light source that transmits a known spectrum of light to said currency specimen; and
a reflection sensor that provides a reflection sensor voltage having an amplitude proportional to an intensity of light of said known spectrum that is reflected from said currency specimen, said comparison means including means for determining when said reflection sensor voltage has an amplitude that is different from an expected amplitude.

12. The currency validator of claim 11 wherein said known light spectrum is orange light.

13. The currency validator of claim 11 wherein said known light spectrum is infra red light.

14. The currency validator of claim 11, additionally comprising a magnetic sensor that provides a magnetic sensor voltage that has an amplitude proportional to a magnetic field intensity proximal to said specimen, said comparison means including means for determining when said magnetic sensor voltage has an amplitude that is different from an expected amplitude.

15. The currency validator of claim 14 wherein said comparison means comprises:
means for providing digital signal representations of the amplitude of said uv sensor voltage, the amplitude of said transmission sensor voltage, the amplitude of said reflection sensor voltage and the amplitude of said magnetic sensor voltage, said digital signal representations collectively forming a resulting digital word;
an e-prom having an input where a digital signal representation of a position within said currency validator of said currency specimen is applied, said e-prom being programmed to provide at its output an expected digital word that is the same as the resulting digital word when said currency specimen is non counterfeit; and
means for comparing said digital words and providing a signal in response to a difference therebetween.

16. In a method of identifying counterfeit currency comprising the steps of:
transmitting uv light to a currency specimen to cause a reflection of uv light therefrom; and
determining when said reflection of uv light has an intensity greater than an expected intensity.

17. In the method of claim 16 comprising the additional step of transmitting a known spectrum of light to said currency specimen, said step of determining including making a further determination of when there is a transmission of light through said currency spectrum that has an intensity that is different from an expected intensity.

18. In the method of claim 17 comprising the additional step of transmitting a known spectrum of light to said currency specimen, said step of determining including making a further determination of when there is a reflection of light through said currency spectrum that has an intensity that is different from an expected intensity.

19. In the method of claim 18 comprising the additional step of sensing a magnetic field intensity proximal to said currency specimen, said step of determining including making a further determination of when said magnetic field intensity is different from an expected field intensity.
